(19) United States
(12) Patent Application Publication
(10) Pub. No.: US 2026/0149574 A1
(43) Pub. Date: May 28, 2026

(54) STORAGE DEVICE AND METHOD FOR GENERATING DEVICE IDENTIFIER

(71) Applicant: Samsung Electronics Co., Ltd., Suwon-si (KR)

(72) Inventors: Gwangbae Choi, Suwon-si (KR); Younsung Chu, Suwon-si (KR); Mungyu Bae, Suwon-si (KR); Jisoo Kim, Suwon-si (KR)

(21) Appl. No.: 19/351,986

(22) Filed: Oct. 7, 2025

(30) Foreign Application Priority Data
Nov. 25, 2024 (KR) 10-2024-0170113

(51) Int. Cl. H04L 9/08; H04L 9/32

(52) U.S. Cl. CPC H04L 9/0866; H04L 9/0825; H04L 9/0869; H04L 9/3247

(57) ABSTRACT

A method of generating the device identifier of the storage device includes generating a first secret key and a first public key of a first layer, generating a signature of the first public key that meets a condition while changing the first variable based on a second secret key of a second layer, the first public key, and a first variable, and storing a first variable value used for generating the signature that meets the condition as the first variable in a non-volatile memory (NVM) device, in which the first variable value is stored in the NVM device during a current booting process, and the signature of the first public key is generated based on the first variable value read from the NVM device during a next booting process.

### CROSS-REFERENCE TO RELATED APPLICATION

This application claims priority under 35 U.S.C. § 119 to Korean Patent Application No. 10-2024-0170113, filed on Nov. 25, 2024, in the Korean Intellectual Property Office, the disclosure of which is incorporated by reference herein in its entirety.

### BACKGROUND

A device identifier composition engine (DICE) is device-related security technology. The DICE safely generates and manages a device identifier unique to a device by combining hardware and software information of the device. The DICE may generate certificate chains for each layer of the device as the device identifier and may generate the device identifier during every booting process of the device. A digital signature algorithm optimized for the DICE is being studied for generating a signature included in a certificate.

### SUMMARY

In general, the present disclosure is directed toward a storage device and a method of generating a device identifier of the storage device, which reduces the time and computation for generating a signature based on a digital signature algorithm optimized for a device identifier composition engine (DICE), thereby reducing the booting time and power consumption.

According to some implementations, the present disclosure is directed to a method of generating the device identifier of the storage device, the method includes generating, by a device identifier composition engine, a first secret key and a first public key of a first layer based on a first hash value of the first layer, generating, by the device identifier composition engine and based on a second secret key of a second layer that is an upper layer of the first layer, the first public key, and a first variable, a signature of the first public key until the signature satisfies a first condition, wherein a value of the first variable is different for each generated signature, storing, by the device identifier composition engine, a first value of the first variable in a non-volatile memory device, wherein the signature that satisfies the first condition is generated based in part on the first value, wherein generating the first secret key, and the signature occur during a first booting process, and wherein storing the first value of the first variable occurs during the first booting process, and during a second booting process subsequent to the first booting process, reading the first value of the first variable from the non-volatile memory device and generating the signature of the first public key based on the first value of the first variable.

According to some implementations, the present disclosure is directed to a method of generating a device identifier of a storage device, the method includes generating, by a device identifier composition engine, a first secret key and a first public key of a current layer, and generating, by the device identifier composition engine, a signature of the first public key based on the first public key of the current layer, a second secret key of a previous layer, a fixed number, and a variable, wherein the generating of the signature includes reading a first value of the variable stored as a value of the variable from a non-volatile memory device, generating a first signature based on the second secret key, the first public key, the fixed number, and the first value of the variable, determining that the first signature fails to satisfy a first condition, based on the first signature failing to satisfy the first condition, repeatedly generating a new signature while changing the value of the variable until the new signature satisfies the first condition, and storing, as the value of the variable in the non-volatile memory device, a second value of the variable associated with the new signature that satisfies the first condition.

According to some implementations, the present disclosure is directed to a storage device that includes non-volatile memory, and a device identifier composition engine configured to generate a first secret key and a first public key of a first layer, a second secret key and a second public key of a second layer, and generate a signature of the second public key based on the first secret key, the second public key, and a first variable, wherein the device identifier composition engine is further configured to generate, during a first booting process, a first signature based on the first secret key, the second public key, and a first value of the first variable, repeatedly generate a new signature while changing the value of the first variable based on the first signature failing to satisfy a condition, and store a second value of the first variable associated with the new signature in the non-volatile memory as the value of the first variable based on the new second signature satisfying the condition.

### BRIEF DESCRIPTION OF THE DRAWINGS

Example implementations will be more clearly understood from the following detailed explanation, taken in conjunction with the accompanying drawings.

FIG. 1 is a block diagram of an example of a system according to some implementations.

FIG. 2 is a diagram of an example of a device identifier according to some implementations.

FIG. 3 is a flowchart of an example of a method of generating a signature according to some implementations.

FIG. 4 is a block diagram of an example of a storage controller according to some implementations.

FIG. 5 is a flowchart of an example of a method of generating a signature according to some implementations.

FIGS. 6A and 6B are flowcharts of an example of a method of generating a signature according to some implementations.

FIG. 7 is a flowchart of an example of a method of generating a signature according to some implementations.

FIGS. 8A, 8B, and 8C are diagrams of an example of a device identifier according to some implementations.

FIG. 9 is a flowchart of an example of a method of generating a device identifier during a booting process of a storage device according to some implementations.

FIG. 10 is a diagram illustrating an example of a method of generating a device identifier according to some implementations.

FIGS. 11A and 11B are diagrams of an example of a device identifier when updating layers in a storage device according to some implementations.

FIG. 12 is a diagram of an example of a storage device according to some implementations.

FIG. 13 is a diagram of an example of a system including a storage device according to some implementations.

FIG. 14 is a block diagram of an example of a device according to some implementations.

### DETAILED DESCRIPTION

Hereinafter, example implementations will be explained in detail with reference to the accompanying drawings.

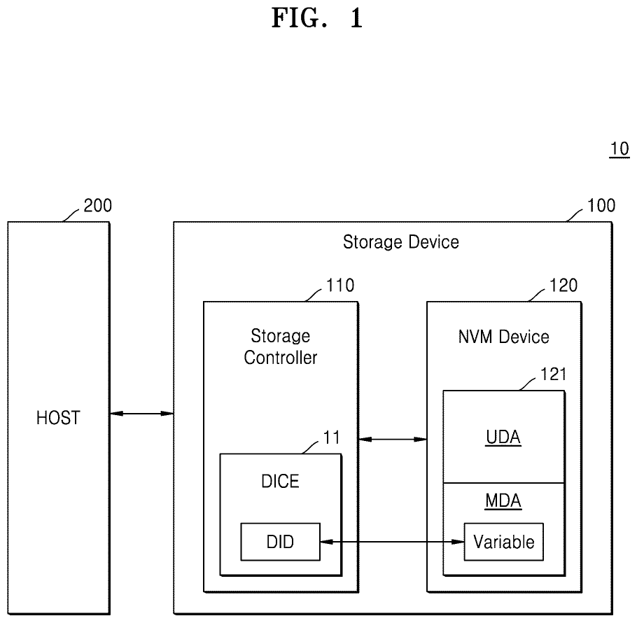

FIG. 1 is a block diagram of an example of a system according to some implementations. In FIG. 1, a system 10 may include a host 200 and a storage device 100. The system 10 may include one of stationary computing systems, such as a desktop computer, a server, a workstation, or the like, or may include a mobile computing system, such as a laptop computer, a tablet personal computer (PC), a notebook computer, a netbook, a mobile device, a smartphone, a personal digital assistant (PDA), or the like.

The host 200 may refer to a data processing device capable of processing data. The host 200 may include a processor that controls the storage device 100. For example, the host 200 may include a central processing unit (CPU), an application processor (AP), a graphics processing unit (GPU), a neural processing unit (NPU), an image signal processor (ISP), and the like. The host 200 may perform an operating system (OS) and/or various application programs. In some implementations, the system 10 may be included in a mobile device, and the host 200 may be implemented as an AP. In some implementations, the host 200 may be implemented as a system-on-a-chip (SoC) and may be embedded in an electronic device.

The host 200 may control a data processing operation, such as a data read operation or a data write operation (or a storage operation), on the storage device 100. The host 200 may receive a unique device identifier from the storage device 100, confirm that the storage device 100 is to be controlled based on the device identifier, and control the data processing operation on the storage device 100.

The storage device 100 may be manufactured as any one of various types of storage devices according to a host interface, which is a method of communication with the host 200. For example, the storage device 100 may include any one of various types of storage devices, such as a solid-state driver (SSD), a multimedia card (MMC), embedded MMC (eMMC), reduced-size MMC (RS-MMC), or micro-MMC, a secure digital card (SD), mini-SD, and micro-SD, a universal serial bus (USB) storage device, a universal flash storage (UFS) device, a personal computer memory card international association (PCMCIA) card, a peripheral component interconnect (PCI) card, a PCI express (PCI-e) card, a compact flash (CF) card, a smart media card, and a memory stick.

When the storage device 100 is an SSD, the storage device 100 may include a device conforming to a non-volatile memory express (NVMe) standard. When the storage device 100 is an embedded memory or an external memory, the storage device 100 may include a device conforming to a UFS or eMMC standard. The host 200 and the storage device 100 may each generate and transmit packets according to the adopted standard protocol. The host 200 and the storage device 100 may transmit/receive encrypted data according to a security protocol and data model (SPDM) standard protocol.

The storage device 100 may be manufactured as any one of various types of package forms. For example, the storage device 100 may be manufactured as any of various types of package forms, such as a package on package (POP), a system in package (SIP), an SoC, a multi-chip package (MCP), a chip on board (COB), a wafer-level fabricated package (WFP), and a wafer-level stack package (WSP).

The storage device 100 may include a storage controller 110 and a non-volatile memory (NVM) device 120 (or NVM 120). The storage device 100 may further include a volatile memory device.

The NVM device 120 may store data. The NVM device 120 may include a memory cell array that includes non-volatile memory cells capable of retaining stored data even when the storage device 100 is powered down, wherein the memory cell array may be divided into a plurality of memory blocks. The plurality of memory blocks may have a two-dimensional (2D) horizontal structure in which memory cells are two-dimensionally arranged or a three-dimensional (3D) vertical structure in which non-volatile memory cells are three-dimensionally arranged on the same plane (or layer).

The plurality of memory blocks may include, for example, flash memory. In some implementations, the plurality of memory blocks may include NAND flash memory. However, the present disclosure is not limited thereto. In some implementations, the plurality of memory blocks may include resistive memory, such as resistive RAM (ReRAM), phase-change RAM (PRAM), or magnetic RAM (MRAM).

The memory cells may each be configured as a single level cell (SLC) that stores one data bit, a multi-level cell (MLC) that stores two data bits, a triple level cell (TLC) that stores three data bits, or a quad level cell (QLC) that stores four data bits.

In some implementations, the NVM device 120 may include a plurality of chips or a plurality of dies, each including a memory cell array. For example, the NVM device 120 may include the plurality of chips, wherein each of the plurality of chips may include the plurality of dies. In some implementations, the NVM device 120 may also include a plurality of channels, each including the plurality of chips.

A storage area 121 (e.g., a plurality of memory blocks) of the NVM device 120 may include a user data area UDA and a metadata area MDA. Data requested to be written from the host 200 may be stored in the user data area UDA. Data generated during an operation of the storage device 100, for example, data for managing the NVM device 120, may be stored in the metadata area MDA. In addition, data for the operation of the storage device 100, such as bootloader and firmware, may be stored in the metadata area MDA.

The storage controller 110 may control the overall operation of the storage device 100 and may manage the NVM device 120. The storage controller 110 may control the NVM device 120 to write data to the NVM device 120, in response to a write request from the host 200, or control the NVM device 120 to read data stored in the NVM device 120, in response to a read request from the host 200.

When power is supplied to the storage device 100, the storage controller 110 may sequentially execute read-only memory (ROM), bootloader, and firmware, according to a booting process.

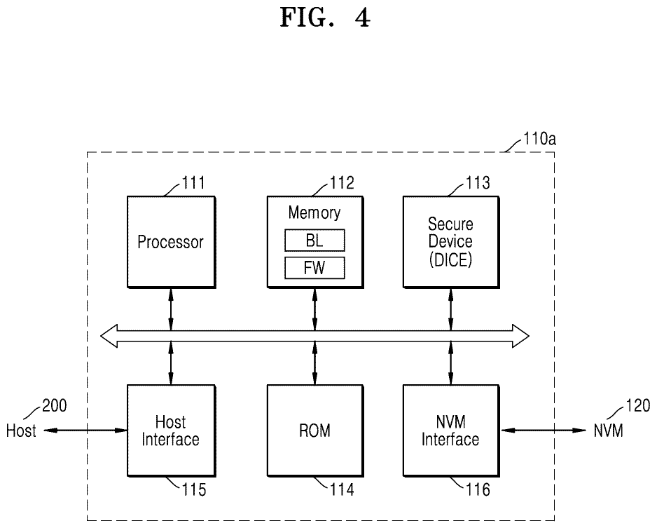

The storage controller 110 may include a device identifier composition engine (DICE) 11. In some implementations, the DICE 11 may be implemented in hardware, e.g., a logic circuit. For example, the hardware may include a logic circuit, an electrical circuit, an electronic circuit, a processor, an integrated circuit, integrated circuit cores, a passive device, or a combination thereof. In some implementations, the DICE 11 may be implemented in software. For example, the software may include machine code, firmware, embedded code, and application software. For example, the DICE 11 may be implemented with instruction sets of firmware and may be executed by a processor (111 of FIG. 4) of the storage controller 110 during the booting process.

The DICE 11 may generate and manage a device identifier DID unique to the storage device 100. The device identifier DID may include a certificate chain including a certificate for each of a plurality of layers of the storage controller 110.

The DICE 11 may generate the device identifier DID by combining hardware information and firmware information of the storage device 100. The DICE 11 may separate hardware and software of the storage device 100 into multiple layers, generate a key pair, i.e., a secret key (or a private key) and a public key, for each layer, and generate a certificate for a public key of a lower layer with a secret key of each layer. Accordingly, the device identifier DID including the certificate chain may be generated. The device identifier DID may be generated on a one-time basis and may not be stored in the NVM device 120. The DICE 11 may generate the device identifier DID during every booting process of the storage device 100.

The device identifier DID may be used during an authentication process of the storage device 100 when the storage device 100 communicates with the host 200 or is connected to a network. For example, the host 200 may receive the device identifier DID from the storage device 100, verify the certificate chain of the device identifier DID based on a pre-stored or highest-level certificate obtained from a server of a manufacturer of the storage device 100, and determine that the storage device 100 is a normal device when the verification is successfully done.

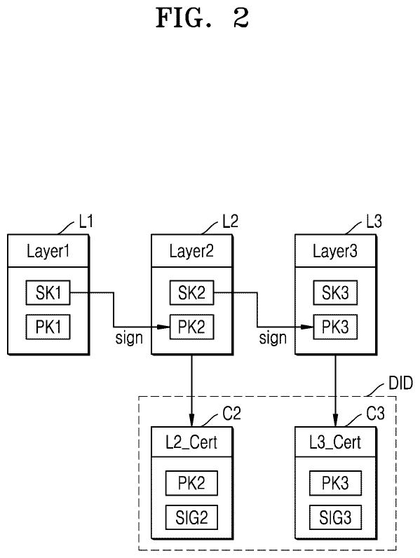

FIG. 2 is a diagram of an example of a device identifier according to some implementations. In FIG. 2, the storage device 100 may include a plurality of layers, for example, a first layer L1, a second layer L2, and a third layer L3. The first layer L1 may be an upper layer of the second layer L2, and the second layer L2 may be an upper layer of the third layer L3. In some implementations, the first layer L1 may include a hardware-based layer and may correspond to, e.g., ROM. In some implementations, the second layer L2 and the third layer L3 may include software-based layers and may correspond to, e.g., bootloader and/or firmware. Each layer may be distinguished by the DICE 11. Although the storage device 100 includes three layers in FIG. 2, the present disclosure is not limited thereto. The storage device 100 may include at least one hardware-based layer and at least one software-based layer.

The DICE 11 may generate a first secret key SK1 and a first public key PK1 of the first layer L1. The DICE 11 may generate the first secret key SK1 and the first public key PK1 (e.g., a key pair) of the first layer L1 based on a unique value of the storage device 100. The unique value may be given to the storage device 100 during a manufacturing process of the storage device 100. For example, the unique value may be stored in one time programmable (OTP) memory. The unique value does not change arbitrarily while the storage device 100 is used.

The DICE 11 may generate a second secret key SK2 and a second public key PK2 of the second layer L2 based on a hash value of the second layer L2. The DICE 11 may sign the second public key PK2 of the second layer L2 based on the first secret key SK1 of the first layer L1. In other words, the DICE 11 may generate a signature SIG2 for the second public key PK2 of the second layer L2. Accordingly, a certificate C2 (L2_Cert) for the second public key PK2 of the second layer L2 may be generated. The certificate C2 may have an X.509 format and may include the second public key PK2 and the signature SIG2.

The DICE 11 may generate a third secret key SK3 and a third public key PK3 of the third layer L3 based on the hash value of the second layer L2 and a hash value of the third layer L3. The DICE 11 may sign the third public key PK3 of the third layer L3 based on the second secret key SK2 of the second layer L2. A signature SIG3 for the third public key PK3 of the third layer L3 may be generated. Thus, a certificate C3 (L3_Cert) for the third public key PK3 may be generated and the certificate C3 (L3_Cert) may include the third public key PK3 and the signature SIG3.

The device identifier DID may include the certificate C2 for the second public key PK2 of the second layer L2 and the certificate C3 for the third public key PK3 of the third layer L3, such as, a certificate chain. In FIG. 2, the device identifier DID may also include a certificate for the first layer L1.

The certificates C2 and C3 are not stored in the NVM device 120, and the DICE 11 generates the certificates C2 and C3, as described above, during every booting process. The key pair of the second layer L2 is generated based on the hash value of the second layer L2, and the key pair of the third layer L3 is generated based on both the hash value of the second layer L2 and the hash value of the third layer L3. Accordingly, when each corresponding layer or an upper layer of the corresponding layer is not changed, the same key pairs for each layer are generated during every booting process. Since the unique value does not change, the same key pairs are generated for each layer during every booting process if the software, e.g., bootloader and/or firmware, are not changed (not updated). Accordingly, the public key is signed with the same secret key during every booting process.

In FIG. 1, in the storage device 100, the DICE 11 may generate the signatures SIG2 and SIG3 based on a module-lattice-based digital signature algorithm (ML-DSA). For example, the DICE 11 may generate a signature that meets (or satisfies) the condition according to Fiat-Shamir with aborts based on the Dilithium signature algorithm. According to the Dilithium signature algorithm, a signature is generated, and it is confirmed whether the signature meets the condition. When the signature does not meet the condition, the signature generation is repeated while changing a variable used for generating the signature until the signature that meets the condition is generated.

The DICE 11 may generate (or output) the signature based on the public key of the layer, the secret key of the upper layer, and the variable. When the generated signature does not meet the condition, the DICE 11 may repeat the signature generation while changing the variable until the signature that meets the condition is generated. In other words, the DICE 11 may repeat the signature generation until the signature that is not vulnerable to security is generated based on a certain condition.

When the signature that meets the condition is generated, the DICE 11 may store a variable (e.g., a variable value) used for generating the signature that meets the condition in the NVM device 120. Subsequently, during the booting process, the DICE 11 may read the variable stored in the NVM device 120 and generate a signature by using the read variable.

For example, the DICE 11 may generate the signature SIG2 for the second public key PK2 of the second layer L2 based on the second public key PK2 of the second layers L2, the first secret key SK1 of the first layer L1, and the first variable during the current booting process and may repeat the signature generation while changing the value of the first variable to generate the signature SIG2 that meets the condition. The DICE 11 may store, a first value of a first variable used for generating the signature SIG2 that meets the condition in the NVM device 120. In addition, the DICE 11 may generate the signature SIG3 that meets the condition by repeating the signature generation for the third public key PK3 of the third layer L3 based on the third public key PK3 of the third layer L3, the second secret key SK2 of the second layer L2, and the second variable, and may store, as a second value of the second variable used for generating the signature SIG3 that meets the condition in the NVM device 120. In some implementations, the first value of the first variable, and the second value of the variable may be stored in the metadata area MDA of the NVM device 120.

During the next booting process, for generating the signature SIG2 for the second public key PK2 of the second layer L2, the DICE 11 may read the value of the first variable, e.g., the first value, from the NVM device 120 and may generate the signature SIG2 by using the first value of the first variable. For generating the signature SIG3 for the third public key PK3 of the third layer L3, the DICE 11 may read the value of the second variable, e.g., the second value, from the NVM device 120 and generate the signature SIG3 by using the second value of the second variable.

When the second layer L2 and the third layer L3 have not been changed before the next booting process, the key pairs of the second layer L2 and the third layer L3 are the same as the key pairs generated during the current booting process. Accordingly, the DICE 11 may directly generate the signature SIG2 that meets the condition based on the first value of the first variable without repeating the signature generation and may directly generate the signature SIG3 that meets the condition based on the second value of the second variable without repeating the signature generation.

When the third layer L3 has been changed before the next booting process, the key pairs of the third layer L3 may be different from the key pairs generated during the current booting process. Since the key pairs of the second layer L2 are not changed, the DICE 11 may directly generate the signature SIG2 of the second public key PK2 that meets the condition based on the first value of the first variable without repeating the signature generation. However, since the key pairs of the third layer L3 have changed, the signature SIG3 of the third public key PK3 generated based on the second value of the second variable may not meet the condition. The DICE 11 may repeat the signature generation while changing the value of the second variable from the second value to another value to generate the signature SIG3 that meets the condition. The DICE 11 may store the third value of the second variable used for generating the signature SIG3 that meets the condition as the value of the second variable in the NVM device 120.

As described above, in the storage device 100, the DICE 11 may store a value of variable used for generating a signature that meets the condition in the NVM device 120 and then generate a signature using the stored value of the variable during the booting process. During the booting process after the bootloader and/or firmware corresponding to the second layer L2 and/or the third layer L3 is updated, the signature generation is repeated for generating the signature that meets the condition. However, when the bootloader and/or firmware is not updated, the signature that meets the condition may be directly generated based on the value of the variable stored in the NVM device 120, without repeating the signature generation. Accordingly, only when the bootloader and/or the firmware is updated (changed), the signature generation may be repeated during the booting process. However, when the bootloader and/or firmware is not updated, the signature generation may not be repeated during the booting process, thereby reducing the time and the computation amount for generating the device identifier DID. Accordingly, the booting time and power consumption of the storage device 100 may be reduced.

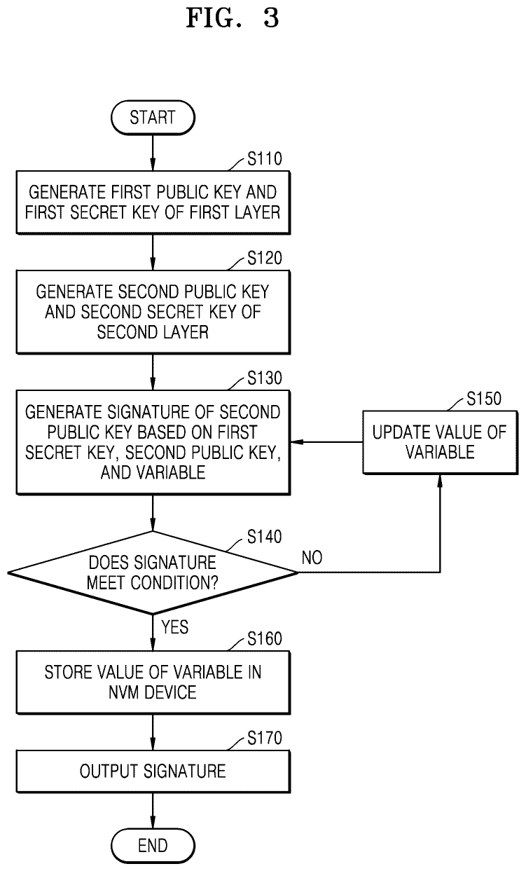

FIG. 3 is a flowchart of an example of a method of generating a signature according to some implementations. The method of generating a signature of FIG. 3 may be performed by the DICE (11 in FIG. 1), and the description made with reference to FIG. 1 may be applied to FIG. 3.

In FIG. 3, the DICE 11 may generate a first secret key and a first public key of a first layer (S110). For example, the first layer corresponds to ROM and the DICE 11 may generate the first secret key and the first public key of the ROM based on a unique value of the storage device (100 in FIG. 1). As another example, the first layer may correspond to a higher layer among the software layers, such as bootloader. The DICE 11 may generate the first secret key and the first public key of the bootloader based on a hash value of the bootloader.

The DICE 11 may generate a second secret key and a second public key of a second layer (S120). The DICE 11 may generate the second secret key and the second public key based on a hash value of the second layer. The DICE 11 may generate a second random value of the second layer based on the first random value of the first layer and the hash value of the second layer and may generate the second secret key and the second public key based on the second random value. The second layer may include a software layer and may correspond to, e.g., bootloader or firmware.

The DICE 11 may generate a signature of the second public key based on the first secret key of the first layer, the second public key of the second layer, and the variable (S130). The DICE 11 may generate a signature based on the ML-DSA. The DICE 11 may generate the signature by inputting the first secret key, the second public key, and a value of the variable to the operation (or function) for generating the signature. In some implementations, the variable may include a counter or a random value. The variable may have a value of “0” or any value or may have a pre-stored value.

In addition to the first secret key, the second public key, and the variable, the DICE 11 may generate the signature by receiving another parameter having a fixed value, for example, a fixed number. For example, the variable may include a counter value and the fixed number may include a random value. As another example, the variable may include a random value and the fixed number may include a counter value.

The DICE 11 may confirm whether the signature meets the condition (S140). For example, the DICE 11 may determine that the signature meets the condition when the value of the signature (or a value of a parameter constituting the signature) is between the first threshold and the second threshold that is greater than the first threshold. The DICE 11 may determine that the signature does not meet the condition when the value of the signature is less than the first threshold or greater than the second threshold. For example, the DICE 11 may determine that the signature meets the condition when at least two parameter values included in the signature are each within a certain range set for each parameter.

When the signature does not meet the condition, the DICE 11 may change the value of the variable (S150). For example, a counter value may be increased (or decreased) by a set unit or a new random number may be generated and used as the random value.

The DICE 11 may generate a signature again based on the changed value of the variable, the first secret key, and the second public key (S130), and may confirm whether the generated signature meets the condition (S140).

The DICE 11 may store the variable in the NVM device (120 in FIG. 1) when the signature meets the condition (S160). The DICE 11 may store the value of the variable used to generate the signature that meets the condition in the NVM device 120. The DICE 11 may output the signature (S170). For example,, a certificate including the second public key and the signature that meets the condition may be generated.

The method of generating a signature of FIG. 3 may be applied to the case where certificates corresponding to software layers of the storage device 100 are generated. For example, the signature SIG2 of the second public key PK2 of the second layer L2 and the signature SIG3 of the third public key PK3 of the third layer L3 in FIG. 2 may be generated according to the method of generating a signature, described with reference to FIG. 3.

The DICE 11 generates the device identifier (DID in FIG. 1) during every booting process of the storage device 100 (or the system (10 of FIG. 1) including the storage device 100). For example, the DICE 11 generates signatures and key pairs for the layers during every booting process. The value of the variable used to generate the signature that meets the condition during the current booting process may be stored in the NVM device 120, and the signature may be generated using the stored value of the variable during the next booting process. When software, e.g., bootloader or firmware, is not updated (not changed) prior to the next booting process, the key pair generated for each layer during the next booting process may be the same as the key pair generated for each layer during the current booting process. Thus, the DICE 11 may use the stored value of the variable to directly generate the signature that meets the condition without repeating the signature generation. The booting time for the storage device 100 may thus be reduced.

FIG. 4 is a block diagram of an example of a storage controller according to some implementations. In FIG. 4, a storage controller 110a may include a processor 111, memory 112, a secure device 113, ROM 114, a host interface 115, and an NVM interface 116. The storage controller 110a may further include components, such as a buffer, an error correction code (ECC) circuit, and the like.

The processor 111 may be implemented as a CPU, a microprocessor, a micro control unit (MCU), an AP, or the like. In some implementations, the processor 111 may be implemented as an SoC. The processor 111 may include homogeneous or heterogeneous multi-cores.

The processor 111 may control the overall operation of the storage device 100 by executing various software (an application program, an OS, a file system, and a device driver) loaded into the memory 112.

The application program or data to be processed by the processor 111 may be loaded into the memory 112. The data to be processed by the processor 111 may be temporarily stored in the memory 112. The memory 112 may be referred to as system memory. The memory 112 may be implemented as volatile memory or non-volatile memory. The volatile memory may include dynamic random-access memory (DRAM) and static RAM (SRAM). The non-volatile memory may include resistive memory, such as ReRAM, PRAM, and MRAM.

During the booting process, bootloader BL and firmware FW stored in the NVM device 120 or the ROM 114 may be loaded into the memory 112. The storage device 100 may be booted and operated based on the bootloader BL and firmware FW. The bootloader BL may include a program (software) that is first executed when the storage device 100 is booted and the bootloader BL may be in charge of the booting process. The bootloader BL may initialize hardware of the storage device 100 and may load the OS into the memory 112. The firmware FW may manage and optimize detailed operations of the storage device 100. The firmware FW may include a flash translation layer (FTL), a host interface layer (HIL), or a flash interface layer (FIL). The firmware FW may perform functions for managing the NVM device 120 or storing and reading data in the NVM device 120, such as address mapping, wear-leveling, and garbage collection.

The secure device 113 may be implemented as or include a DICE. The secure device 113 may generate the device identifier DID based on software images (e.g., bootloader BL and/or firmware FW) and unique information (e.g., unique value) of the storage device 100. In FIGS. 1, 2, and 3, the secure device 113 may generate a key pair for each layer and may generate a signature that meets the condition by repeating the signature generation according to the ML-DSA. The secure device 113 may store, in the NVM device 120, a value of a variable used to generate the signature that meets the condition, read the value of the variable from the NVM device 120 during the next booting process, and generate the signature based on the read value of the variable.

The ROM 114 may store information (data) set during a manufacturing process of the storage device 100. For example, the ROM 114 may store unique information, such as a unique value, of the storage device 100. The value stored in the ROM 114 does not change. In some implementations, the ROM 114 may store software images non-volatilely. In some implementations, the ROM 114 may store the bootloader BL including instructions preferentially executed by the processor 111 and the firmware FW executed by the bootloader BL when power is supplied to the storage controller 110a or the storage controller 110a is reset.

The ROM 114 may be implemented as programmable read-only memory (PROM), erasable programmable read-only memory (EPROM), electrically erasable programmable read-only memory (EEPROM), or the like.

The host interface 115 may be in communication with the host 200. The host interface 115 may transmit/receive commands and data to/from the host 200, according to a preset protocol. In some implementations, the host interface 115 may transmit/receive commands and data to/from the host 200, according to an SPDM standard protocol.

The NVM interface 116 may transmit, to the NVM device 120, data to be written to the NVM device 120 or may receive, from the NVM device 120, data read from the NVM device 120. The NVM interface 116 may be implemented to comply with standard protocols, such as Toggle or open NAND flash interface (ONFI).

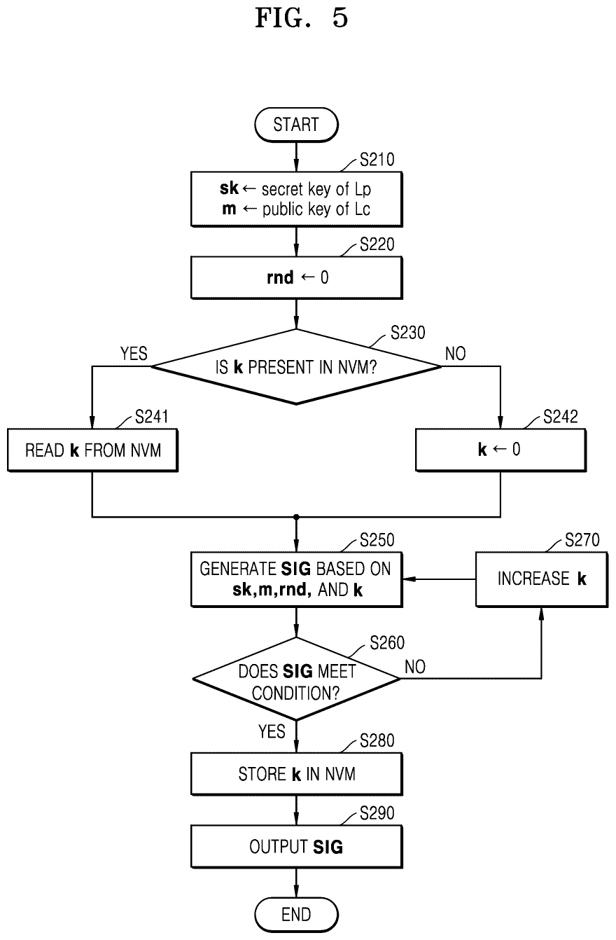

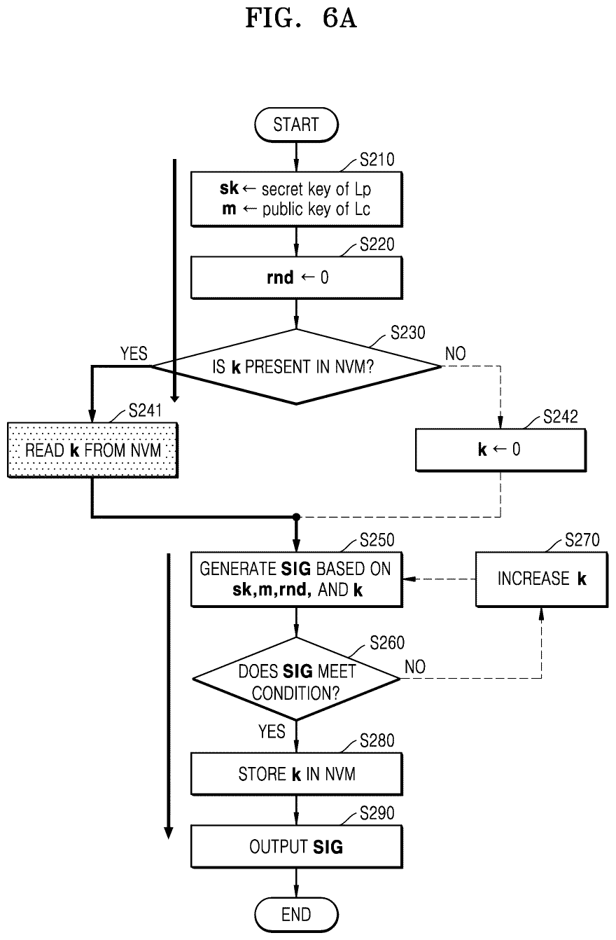

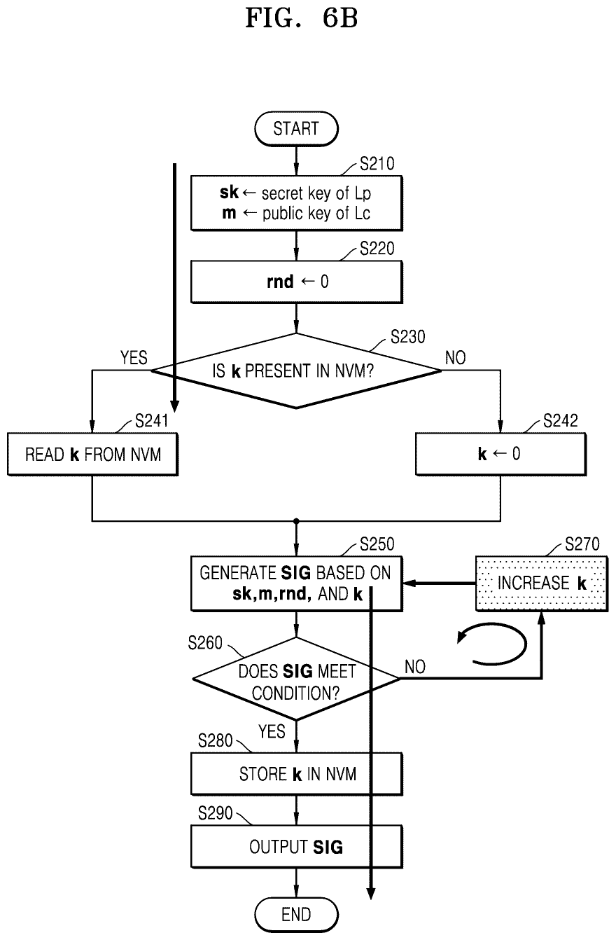

FIGS. 5, 6A, and 6B are flowcharts of an example of a method of generating a signature according to some implementations. FIGS. 5, 6A and 6B illustrate an algorithm for generating a signature, performed by the DICE (11 in FIG. 1).

In FIG. 5, the DICE 11 may generate a signature SIG by receiving a secret key sk, a message m, a random value rnd, and a counter value k. The random value rnd is a fixed number, and the counter value k is a variable. For example, the counter value k may be 2 bytes of data.

A secret key of a previous layer Lp may be received as the secret key sk, and a public key of a current layer Lc may be received as the message m (S210). The current layer Lc refers to a layer in which the signature SIG is to be generated, and the previous layer Lp is an upper layer of the current layer Lc. The secret key and the public key of the previous layer Lp are generated before the secret key and the public key of the current layer Lc, and the signature of the previous layer Lp is generated before the signature of the current layer Lc.

The random value rnd may be set to “0” (S220). As the random value rnd is set to “0”, the same signature SIG may be generated for the same inputs.

The DICE 11 may confirm whether the counter value k is present in NVM (120 in FIG. 1) (S230). The DICE 11 may confirm whether the counter value k was previously stored in the NVM 120.

When the counter value k is stored in the NVM 120, the counter value k may be read from the NVM 120 (S241). When the counter value k is not stored in the NVM 120, the counter value k may be set to “0” (S242). In some implementations, the counter value k may be set to any value.

The DICE 11 may generate the signature SIG based on the secret key sk, the message m, the random value rnd, and the counter value k (S250). The DICE 11 may generate the signature SIG according to the operation of generating the signature by receiving the secret key sk, the message m, the random value rnd, and the counter value k.

The DICE 11 may determine whether the signature SIG meets the condition (S260). For example, the DICE 11 may determine that the signature SIG meets the condition when the value of the signature is in a set range, or when the values of a plurality of parameters constituting the signature are in a set range for each parameter.

If the signature SIG does not meet the condition, the DICE 11 may increase the counter value k by a set unit (S270), and generate the signature SIG again in operation S250 based on the increased counter value k.

As such, the DICE 11 may repeat the signature generation while increasing the counter value k until the signature SIG that meets the condition is generated. In other words, the DICE 11 may repeat the loop including operations S250, S260 and S270.

When the signature SIG meets the condition, the DICE 11 may store the counter value k in the NVM 120 (S280). The counter value k (counter value) used to generate the signature SIG that meets the condition may be stored in the NVM 120.

The DICE 11 may output the signature SIG (S290). Accordingly, a certificate including the message m and the signature SIG may be generated.

In FIG. 6A, when the current layer and the previous layer (e.g., bootloader and firmware) are not updated before the next booting process, the DICE 11 may read the stored counter value k from the NVM 120 during the next booting process, and directly generate the signature SIG that meets the condition by using the read counter value k. The DICE 11 may directly generate the signature SIG that meets the condition by performing operations S210, S220, S230, S241, S250, and S260, without repeating the loop including operations S250, S260, and S270.

In FIG. 6B, when the current layer and the previous layer (e.g., bootloader and firmware) are updated before the next booting process, it is highly likely that the signature SIG that meets the condition is not directly generated even though the signature is generated using the read counter value k read from the NVM 120 during the next booting process. Thus, the DICE 11 may repeat the loop including operations S250, S260, and S270 to generate the signature SIG that meets the condition. In addition, when the counter value k stored in the NVM 120 is unintentionally changed (or modulated) before the next booting process, it is difficult to directly generate the signature SIG that meets the condition even though the current layer and the previous layer are not changed, and the loop including operations S250, S260, and S270 may be repeated to generate the signature SIG that meets the condition.

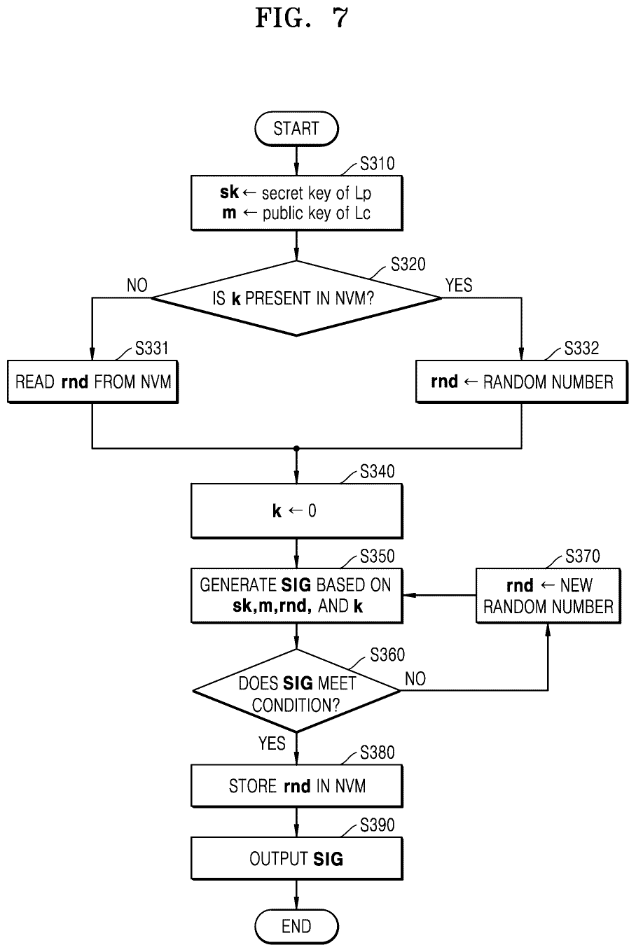

FIG. 7 is a flowchart of an example of a method of generating a signature according to some implementations. FIG. 7 shows the algorithm for generating the signature, performed by the DICE (11 in FIG. 1).

In FIG. 7, the DICE 11 may generate the signature SIG by inputting the secret key sk, the message m, the random value rnd, and the counter value k. The random value rnd may be a variable, and the counter value k may be a fixed number. Operations S310, S350, S360, and S390 are respectively the same as operations S210, S250, S260, and S290 in FIG. 5, and thus the detailed description thereof is omitted.

A secret key of the previous layer Lp may be received as the secret key sk, and a public key of the current layer Lc may be received as the message m (S310).

The DICE 11 may confirm whether the random value rnd is present in the NVM (120 in FIG. 1) (S320). The DICE 11 may confirm whether the random value rnd was previously stored in the NVM 120.

When the random value rnd is stored in the NVM 120, the random value rnd may be read from the NVM 120 (S331). When the random value rnd is not stored in the NVM 120, the DICE 11 may generate a random number and set the random number to the random value rnd (S332).

The counter value k may be set to “0” (S340). The same signature SIG may be generated for the same inputs as the counter value k is set to “0”.

The DICE 11 may generate the signature SIG based on the secret key sk, the message m, the random value rnd, and the counter value k (S350), and may determine whether the generated signature SIG meets the condition (S360).

When the signature SIG does not meet the condition, the DICE 11 may change the random value rnd (S370). The DICE 11 may generate a new random number and set the new random number to the random value rnd. The DICE 11 may generate the signature SIG again in operation S350 based on the changed random value rnd.

As such, the DICE 11 may repeat the signature generation while changing the random value rnd until the signature SIG that meets the condition is generated. In other words, the DICE 11 may repeat the loop including operations S350, S360 and S370.

When the signature SIG meets the condition, the DICE 11 may store the random value rnd in the NVM 120 (S380). The random value rnd (random number) used to generate the signature SIG that meets the condition may be stored in the NVM 120.

The DICE 11 may output the signature SIG (S390). Accordingly, a certificate including the message m and the signature SIG may be generated.

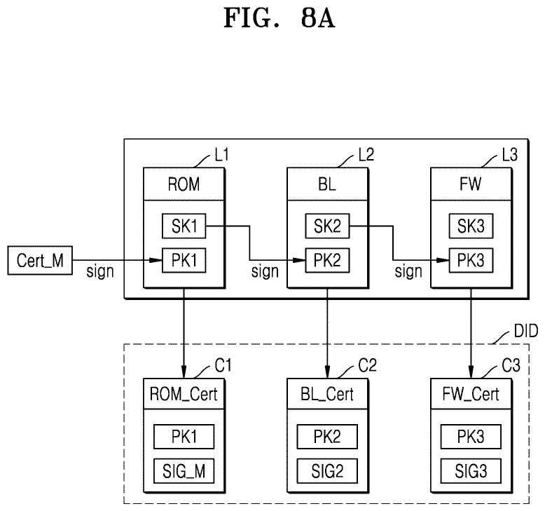

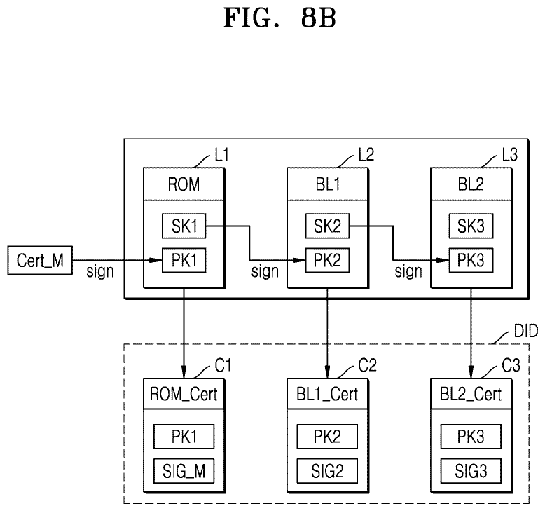

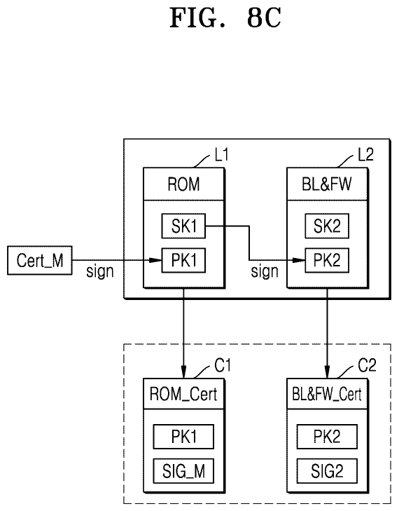

FIGS. 8A, 8B, and 8C are diagrams of an example of a device identifier according to some implementations. In FIG. 8A, the DICE (11 in FIG. 1) may distinguish hardware and software of the storage device (100 in FIG. 1) into first to third layers L1, L2, and L3. The first layer L1 may correspond to ROM, the second layer L2 may correspond to bootloader, and the third layer L3 may correspond to firmware.

The DICE 11 may generate a key pair of a ROM layer, e.g., a first secret key SK1 and a first public key PK1 of the first layer L1, based on a unique value of the storage device 100. Since the unique value of the storage device 100 does not change, the first secret key SK1 and the first public key PK1 of the first layer L1 always have the same values during every booting process and do not change.

The first public key PK1 of the first layer L1 may be signed based on a manufacturer's certificate Cert_M to generate a signature SIG_M. The certificate C1 (e.g., ROM_Cert) of the first layer L1 may include a first public key PK1 and the signature SIG_M. The certificate C1 of the first layer L1 may be referred to as a device ID (identifier) certificate. The device ID certificate may not be generated during every booting process and may be stored in the ROM (114 in FIG. 4) or the NVM device 120 while manufacturing the storage device 100.

The DICE 11 may generate the second secret key SK2 and the second public key PK2 of the second layer L2, e.g., a bootloader layer, based on the hash value of the bootloader BL. The DICE 11 may sign the second public key PK2 of the second layer L2 with the first secret key SK1 of the first layer L1 to generate a signature SIG2. The signature SIG2 may be generated according to the method of generating a signature, described with reference to FIG. 3, and 5 to 7. Accordingly, the certificate C2 (e.g., BL_Cert) of the second layer L2 including the second public key PK2 and the signature SIG2 may be generated.

The DICE 11 may generate the third secret key SK3 and the third public key PK3 of the third layer L3, e.g., a firmware layer, based on the hash value of the firmware FW. The DICE 11 may sign the third public key PK3 of the third layer L3 with the second secret key SK2 of the second layer L2 to generate a signature SIG3. The signature SIG3 may be generated according to the method of generating a signature, described with reference to FIGS. 3 and 5 to 7. Accordingly, the certificate C3 (e.g., FW_Cert) of the third layer L3 including the third public key PK3 and the signature SIG3 may be generated.

The device identifier DID may include a certificate chain based on the certificates C1, C2, and C3 corresponding to the plurality of layers L1, L2, and L3, respectively.

In FIG. 8B, the DICE (11 in FIG. 1) may distinguish hardware and software of the storage device 100 (FIG. 1) into the first to third layers L1, L2, and L3. The first layer L1 may correspond to ROM, the second layer L2 may correspond to a first bootloader BL1, and the third layer L3 may correspond to a second bootloader BL2. The first bootloader BL1 may refer to a part of the bootloader, for example, a half of the bootloader, and the second bootloader BL2 may refer to another part of the bootloader, for example, the other half of the bootloader.

The DICE 11 may generate the second secret key SK2 and the second public key PK2 based on the hash value of the first bootloader BL1 and may generate the third secret key SK3 and the third public key PK3 based on the hash value of the second bootloader BL2. The generation of the certificates C1, C2 (e.g., BL1_Cert), and C3 (e.g., BL2_Cert) is the same as that described with reference to FIG. 8A, and redundant description thereof is omitted.

In FIG. 8C, the DICE (11 in FIG. 1) may distinguish hardware and software of the storage device 100 (FIG. 1) into the first layer L1 and the second layer L2. The first layer L1 may correspond to ROM, and the second layer L2 may correspond to bootloader BL and firmware FW. The DICE 11 may generate the second secret key SK2 and the second public key PK2 based on hash values (e.g., hash values of firmware images) of the bootloader BL and the firmware FW.

The device identifier DID may include a certificate chain including the certificate C1 corresponding to the first layer L1 and the certificate C2 (e.g., BL&FW_Cert) corresponding to the second layer L2.

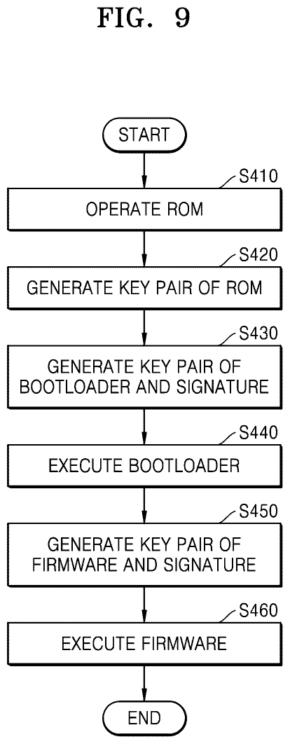

FIG. 9 is a flowchart of an example of a method of generating a device identifier during a booting process of a storage device according to some implementations.

When power is supplied to the storage device (100 in FIG. 1) or the storage device 100 is reset, a booting process of the storage device 100 may be performed. The ROM, the bootloader BL, and the firmware FW may be executed sequentially to initialize hardware, and the OS and/or firmware FW may be loaded into the memory (112 in FIG. 4).

In FIG. 9, the ROM may be operated (S410). Based on setting values or information stored in the ROM, the hardware may be initialized or some configurations within the storage controller (110 of FIG. 1) may be operated. For example, the DICE (11 in FIG. 1) may be called by the setting values or instructions stored in the ROM.

The DICE 11 may generate a key pair of the ROM (S420). When the ROM is operated, the DICE 11 may generate the secret key and the public key of the ROM based on the unique value of the storage device (100 in FIG. 1). For example, the DICE 11 may read the unique value from an OTP, generate a random value of the ROM based on the unique value, and then generate a secret key and a public key based on the random value.

The DICE 11 may generate a signature and a key pair of the bootloader BL (S430). The DICE 11 may receive the hash value of the bootloader BL, generate a random value of the bootloader BL based on the random value of the ROM and the hash value of the bootloader BL, and generate a secret key and a public key of the bootloader BL based on the random value. The DICE 11 may sign the public key of the bootloader BL with the secret key of the ROM. Accordingly, a certificate of the bootloader BL may be generated.

Thereafter, the bootloader BL may be executed (S440), and the DICE 11 may transfer the secret key and the public key of the bootloader BL to the bootloader BL.

When the bootloader BL is executed, the DICE 11 may generate a signature and a key pair of the firmware FW (S450). The signature may be generated according to the method of generating a signature, described with reference to FIG. 3, and 5 to 7. The DICE 11 may receive the hash value of the firmware FW, generate a random value of the firmware FW based on the random value of the bootloader BL and the hash value of the firmware FW, and generate a secret key and a public key of the firmware FW based on the random value. The DICE 11 may sign the public key of the firmware FW with the secret key of the bootloader BL. Accordingly, a certificate of the firmware FW may be generated. Thereafter, the firmware FW may be executed (S460), and the DICE 11 may transfer the secret key and the public key of the firmware FW to the firmware FW.

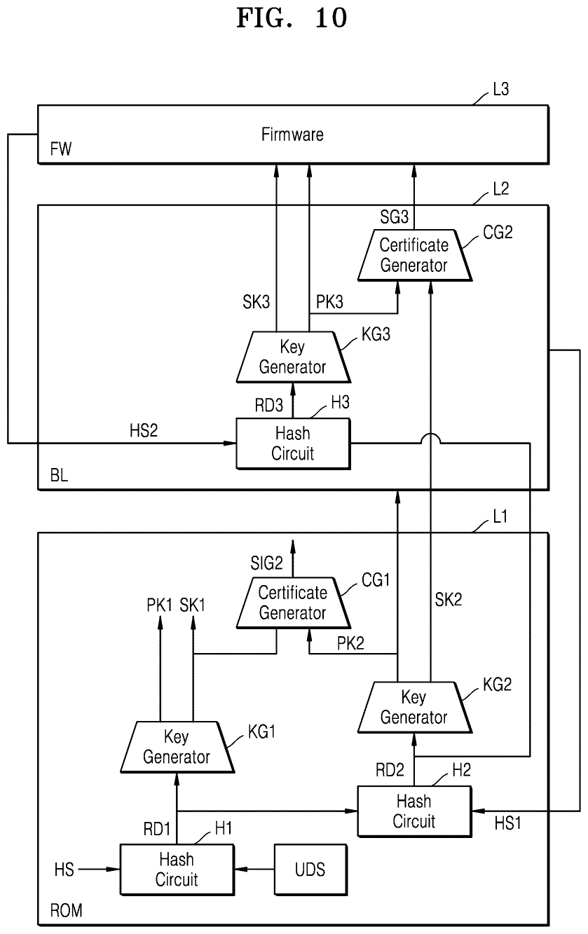

FIG. 10 is a diagram illustrating an example of a method of generating a device identifier according to some implementations. In FIG. 10, the storage device 100 in FIG. 1 may be distinguished into the first layer L1, the second layer L2, and the third layer L3 by the DICE (11 in FIG. 1). For example, the first layer L1 may correspond to ROM, the second layer L2 may correspond to bootloader, and the third layer L3 may correspond to firmware. However, the present disclosure is not limited thereto. The layers may be changed as described with reference to FIGS. 8A to 8C.

The first layer L1 may include hash circuits H1 and H2, key generators KG1 and KG2, and a certificate generator CG1. In some implementations, the hash circuits H1 and H2, the key generators KG1 and KG2, and the certificate generator CG1 may be implemented as program modules or instructions executed by the DICE 11.

Each time the storage device 100 is reset or powered up, the first hash circuit H1 may generate a first random value RD1 by using a unique device secret (UDS) value and a hash value HS of the first layer L1 as input values. The first random value RD1 may be referred to as a compound device identifier (CDI). The first hash circuit H1 may generate the first random value RD1 based on a hash-based message authentication code (HMAC). The UDS value may be given to the storage device 100 during the manufacturing process of the storage device 100 and may be managed so as not to be disclosed to the outside. The UDS value may be determined based on a random number generated by a random number generator.

The first key generator KG1 may generate a key pair of the first layer L1, for example, the first secret key SK1 and the first public key PK1, based on the first random value RD1. The first public key PK1, e.g., the public key of the ROM, may correspond to the device ID. The first public key PK1 may be signed with the manufacturer's certificate. In some implementations, the device ID certificate may not be generated during every booting process, like other certificates, e.g., certificates of the second layer L2 and the third layer L3. The device ID certificate may be stored in the ROM or NVM device (120 in FIG. 1) while manufacturing the storage device 100.

The second hash circuit H2 may generate a second random value RD2 by using the first random value RD1 and the hash value HS1 of the second layer L2 as input values. The second hash circuit H2 may be implemented identically or similarly to the first hash circuit H1 and may generate the second random value RD2 based on the HMAC.

The second key generator KG2 may generate a key pair of the second layer L2, for example, the second secret key SK2 and the second public key PK2, based on the second random value RD2.

The first certificate generator CG1 may generate the certificate of the second layer L2 based on the first secret key SK1 and the second public key PK2. The first certificate generator CG1 may generate the signature SIG2 for the second public key PK2 based on the ML-DSA, e.g., the Dilithium signature algorithm, as described with reference to FIGS. 3 and 5 to 7.

The second layer L2, e.g., bootloader BL, may be executed, and the second layer L2 may receive the second secret key SK2 and the signed second public key PK2, such as the second public key PK2 and the signature SIG2. The second layer L2 may also receive the second random value RD2.

A third hash circuit H3 may generate the third random value RD3 by using the second random value RD2 and the hash value HS2 of the third layer L3 as input values. The third hash circuit H3 may be implemented identically or similarly to the first hash circuit H1 and may generate the third random value RD3 based on the HMAC.

A third key generator KG3 may generate a key pair of the third layer L3, for example, the third secret key SK3 and the third public key PK3, based on the third random value RD3.

A second certificate generator CG2 may generate the certificate of the third layer L3 based on the second secret key SK2 and the third public key PK3. The second certificate generator CG2 may generate the signature SIG3 for the third public key PK3 based on the ML-DSA, e.g., the Dilithium signature algorithm, as described with reference to FIGS. 3 and 5 to 7.

The third layer L3, e.g., firmware FW, may be executed, and the third layer L3 may receive the third secret key SK3 and the signed third public key PK3, such as the third public key PK3 and the signature SIG3.

The third secret key SK3 of the third layer L3 may be used when a certificate is required for the SPDM protocol in the storage device 100.

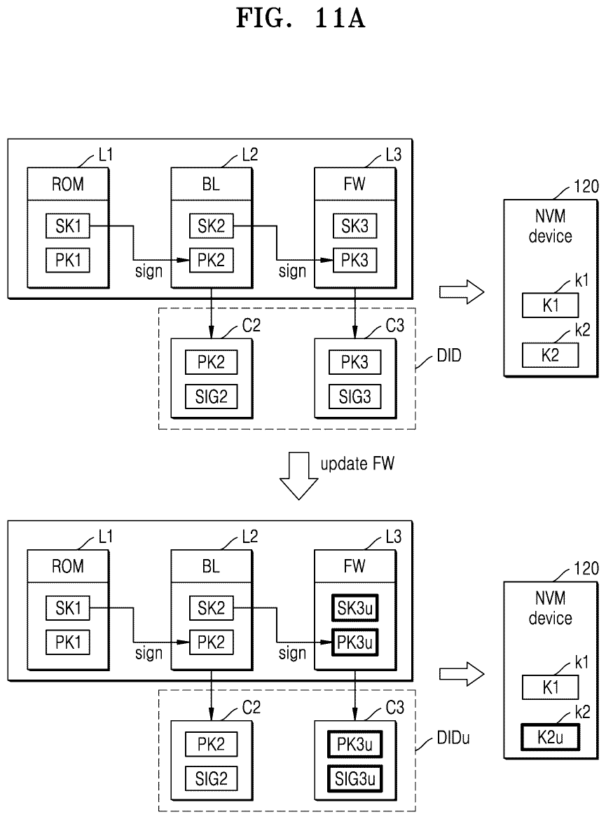

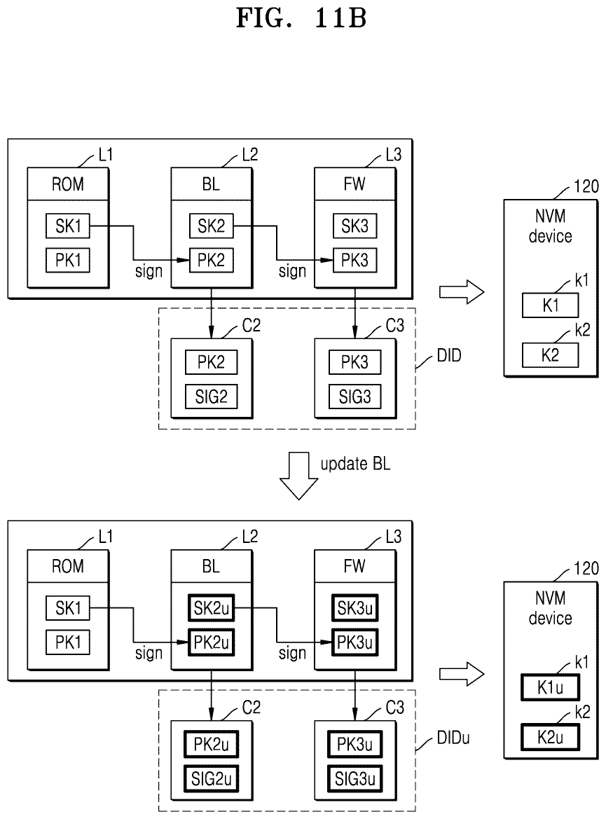

FIGS. 11A and 11B are diagrams of an example of a device identifier when updating layers in a storage device according to some implementations. In FIG. 11A, during the booting process, the DICE (11 in FIG. 1) may generate a key pair for each of the plurality of layers L1, L2, and L3, and generate signatures SIG2 and SIG3 for the second public key PK2 of the second layer L2 and the third public key PK3 of the third layer L3, respectively. Thus, the device identifier DID, which includes the certificate C2 including the second public key PK2 and the signature SIG2 and the certificate C3 including the third public key PK3 and the signature SIG3, may be generated. A first value of the first variable k1, e.g., K1, used when generating the signature SIG2 that meets the condition for the second public key PK2 may be stored as a value of the first variable k1 in the NVM device 120, and a second value of the second variable k2, e.g., K2, used when generating the signature SIG3 that meets the condition for the third public key PK3 may be stored as a value of the second variable k2 in the NVM device 120.

Subsequently, before the next booting process, the firmware FW may be updated. Accordingly, a secret key SK3u and a public key PK3u of the third layer L3 generated during the next booting process may be different from the secret key SK3 and the public key PK3 of the third layerL3 generated during the previous booting process. Accordingly, since the public key PK3 of the third layer L3 is changed, the signature generation may be repeated to generate the signature that meets the condition even though the signature is generated based on the second value K2 of the second variable k2 stored in the NVM device 120 during the previous booting process. A signature SIG3u that meets the condition may be generated, wherein the signature SIG3u may be different from the signature SIG3 generated during the previous booting process. A third value of the second variable value k2, e.g., K2u, used for generating the signature SIG3u that meets the condition may be stored as the value of the second variable k2 in the NVM device 120. Accordingly, the value of the second variable k2 may be updated. In addition, since the ROM and the bootloader BL are not updated before the next booting process, a secret key SK2 and a public key PK2 of the second layer L2 generated during the next booting process may be the same as the secret key SK2 and the public key PK2 of the second layer L2 generated during the previous booting process. Thus, the updated device identifier DIDu, which includes the certificate C2 including the second public key PK2 and the signature SIG2 and the certificate C3 including the third public key PK3u and the signature SIG3u, may be generated.

In FIG. 11B, the bootloader BL may be updated before the next booting process. Accordingly, a secret key SK2u and a public key PK2u of the second layer L2 generated during the next booting process may be different from the secret key SK2 and the public key PK2 of the second layer L2 generated during the previous booting process. In addition, as described with reference to FIG. 10, since the hash value of the second layer L2 is used when generating the secret key SK3u and the public key PK3u of the third layer L3, the secret key SK3u and the public key PK3u of the third layer L3 may also be different from the secret key SK3 and the public key PK3 of the third layer L3 generated during the previous booting process.

Accordingly, the signature generation may be repeated to generate the signature SIG2u that meets the condition for the second public key PK2u and the signature SIG3u that meets the condition for the third public key PK3u, each generated during the next booting process. The signature SIG2u for the second public key PK2u and the signature SIG3u for the third public key PK3u may be different from the signature SIG2 for the second public key PK2 and the signature SIG3 for the third public key PK3, each generated during the previous booting process. Thus, the updated device identifier DIDu, which includes the certificate C2 including the second public key PK2u and the signature SIG2u and the certificate C3 including the third public key PK3u and the signature SIG3u, may be generated.

The values of the variables, e.g., K1u and K2u, used when generating the signatures SIG2u and SIG3u that meet the condition may be stored in the NVM device 120 as the value of the first variable k1 and the value of the second variable k2, respectively. Accordingly, the value of the first variable k1 and the value of the second variable k2 may be updated.

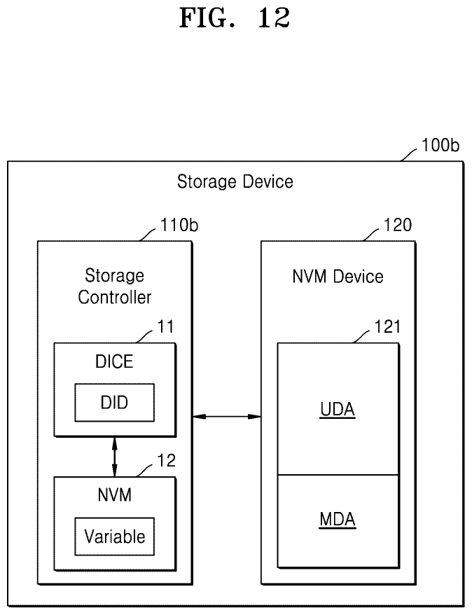

FIG. 12 is a diagram of an example of a storage device according to some implementations.

A storage device 100b may include a storage controller 110b and an NVM device 120. The operation of the storage device 100b is substantially the same as that of the storage device 100 of FIG. 1. The DICE 11 may generate the device identifier DID. As described with reference to FIG. 3, and 5 to 7, the DICE 11 may repeat the signature generation according to the ML-DSA to generate the signature that meets the condition.

In some implementations, the storage controller 110b may include NVM 12. For example, the NVM 12 may include resistive memory such as ReRAM, PRAM, or MRAM. The DICE 11 may store a value of a variable used for generating the signature that meets the condition in the NVM 12.

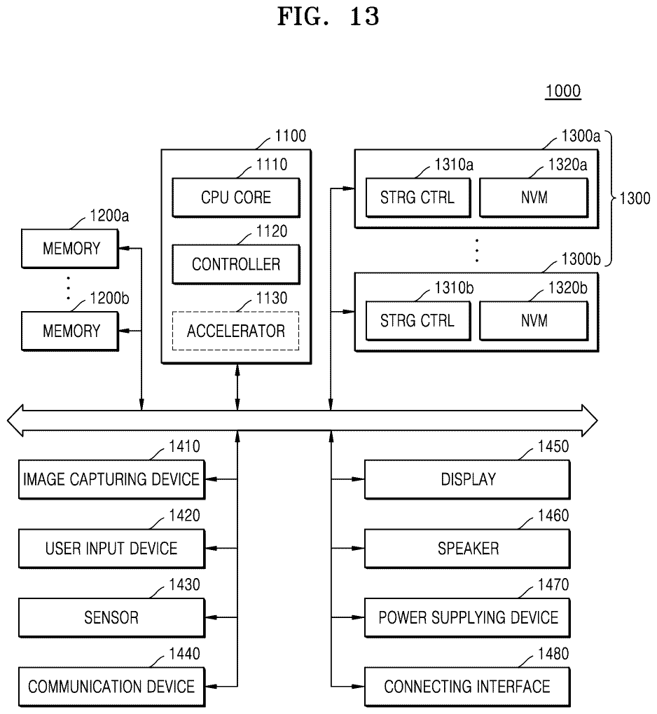

FIG. 13 is a diagram of an example of a system including a storage device according to some implementations.

Basically, a system 1000 of FIG. 13 may include a mobile system, such as a mobile phone, a smartphone, a tablet PC, a wearable device, a healthcare device, or an internet of things (IOT) device. However, the system 1000 of FIG. 13 is not necessarily limited to the mobile system. The system 1000 may include a PC, a laptop computer, a server, a media player, or an automotive device such as navigation.

In FIG. 13, the system 1000 may include a main processor 1100, memories 1200a and 1200b, and a storage system 1300, and may further include one or more of an image capturing device 1410, a user input device 1420, a sensor 1430, a communication device 1440, a display 1450, a speaker 1460, a power supplying device 1470, and a connecting interface 1480.

The main processor 1100 may control the overall operation of the system 1000, and more specifically, the operation of the other components constituting the system 1000. The main processor 1100 may be implemented as a general-purpose processor, a dedicated processor, or an AP.

The main processor 1100 may include one or more CPU cores 1110 and may further include a controller 1120 for controlling the memories 1200a and 1200b and/or the storage system 1300. According to some implementations, the main processor 1100 may further include an accelerator 1130 which is a dedicated circuit for high-speed data operation, such as artificial intelligence (AI) data operation. The accelerator 1130 may include a GPU, an NPU, and/or a data processing unit (DPU), and may be implemented as a separate chip physically independent of other components of the main processor 1100.

The memories 1200a and 1200b may be used as the main memory of the system 1000 and may include volatile memory, such as SRAM and/or DRAM. The memories 1200a and 1200b may also include non-volatile memory, such as flash memory, PRAM, and/or RRAM. The memories 1200a and 1200b may be implemented in the same package as the main processor 1100.

The storage system 1300 may include a storage device 1300a and a storage device 1300b. The storage device 1300a and the storage device 1300b may be configured to be included in one memory package. The storage devices 1300a and 1300b may function as a non-volatile storage device that stores data regardless of whether power is supplied and may have a relatively large storage capacity, compared to the memories 1200a and 1200b. The storage devices 1300a and 1300b may include storage controllers 1310a and 1310b, and NVMs 1320a and 1320b that store data under the control by the storage controllers 1320a and 1320b, respectively. The NVMs 1320a and 1320 b may include flash memory of a 2D structure or 3D vertical NAND (V-NAND) structure. However, the NVMs 1320a and 1320b may also include other types of non-volatile memory, such as PRAM and/or RRAM.

The storage system 1300 may be included in the system 1000 physically separate from the main processor 1100 or may be implemented in the same package as the main processor 1100. In addition, the storage system 1300 may have the form of SSD or memory card and may be detachably coupled to other components of the system 1000 through an interface, such as the connecting interface 1480 to be described below.

The storage devices 100 and 100b described with reference to FIGS. 1 and 12 may be used as the storage devices 1300a and 1300b, respectively. The DICE may generate a device identifier in each of the storage devices 1300a and 1300b. The DICE may generate the device identifier during every booting process and may generate a certificate chain of a plurality of layers as the device identifier. The DICE may generate the signature according to the ML-DSA. The DICE may generate the signature that meets the condition by repeating the signature generation while changing a value of a variable, store a first value of the variable used for generating the signature that meets the condition in the NVM, and then quickly generate the signature that meets the condition based on the stored first value of the variable during the booting process. Accordingly, the booting time for the storage devices 1300a and 1300b and system 1000 may be reduced.

The image capturing device 1410 may capture a still image or a moving image, and may include a camera, a camcorder, and/or a webcam.

The user input device 1420 may receive various types of data input from a user of the system 1000 and may include a touchpad, a keypad, a keyboard, a mouse, and/or a microphone.

The sensor 1430 may sense various types of physical quantities which can be obtained from the outside of the system 1000 and may convert the sensed physical quantities into electrical signals. The sensor 1430 may include a temperature sensor, a pressure sensor, an illuminance sensor, a position sensor, an acceleration sensor, a biosensor, and/or a gyroscope sensor.

The communication device 1440 may exchange signals with other devices outside the system 1000, according to various communication protocols. The communication device 1440 may be implemented including an antenna, a transceiver, and/or a modem.

The display 1450 and the speaker 1460 may function as an output device that outputs visual information and auditory information, respectively, to the user of the system 1000.

The power supplying device 1470 may convert power supplied from a battery built in the system 1000 and/or an external power source and supply the power to each component of the system 1000.

The connecting interface 1480 may be connected to the system 1000 to provide connection between the system 1000 and an external device capable of exchanging data with the system 1000. The connecting interface 1480 may be implemented in various interface manners, such as advanced technology attachment (ATA), serial ATA (SATA), external SATA (e-SATA), small computer small interface (SCSI), serial attached SCSI (SAS), PCI, PCIe, NVMe, IEEE 1394, USB, SD card, MMC, eMMC, UFS, embedded UFS (eUFS), CF card interface, and the like.

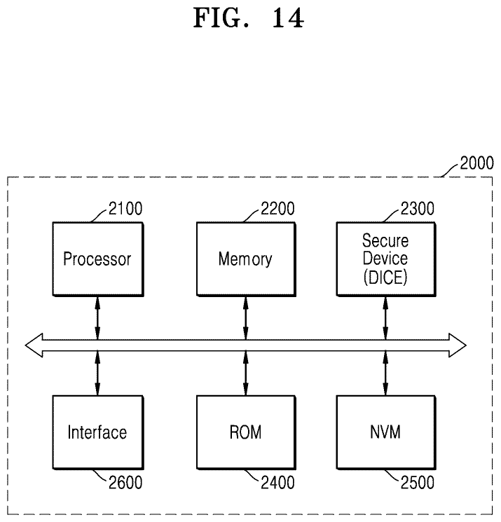

FIG. 14 is a block diagram of an example of a device according to some implementations.

A device 2000 may include a processor 2100, memory 2200, a secure device 2300, ROM 2400, NVM 2500, and an interface 2600. In addition, the device 2000 may further include other components, for example, a power management unit, a CPU, and a clock unit. In some implementations, the device 2000 may be implemented as a SoC.

The processor 2100 may control the overall operation of the device 2000. The memory 2200 may be implemented as volatile memory, e.g., RAM. The memory 2200 may be loaded with an application program or data to be processed by the processor 2100. For example, during the booting process, bootloader and firmware may be loaded into the memory 2200.

The secure device 2300 may be implemented as or include a DICE. The secure device 113 may generate a device identifier. The secure device 2300 may generate the device identifier based on hardware and software information of the device 2000. The secure device 2300 may generate a key pair for each layer of the device 2000 and may generate a signature that meets the condition by repeating the signature generation according to the ML-DSA. The secure device 2300 may store a value of a variable used to generate the signature that meets the condition in the NVM 2500, read the value of the variable from the NVM 2500 during the next booting process, and generate the signature based on the read value of the variable.

The ROM 2400 may store information (data) set during a manufacturing process of the device 2000. For example, the ROM 2400 may store unique information of the device 2000, such as a unique value.

The NVM 2500 may include resistive memory, such as ReRAM, PRAM, or MRAM, or flash memory. The NVM 2500 may store bootloader and/or firmware. The value of the variable used for generating the signature may also be stored in the NVM 2500.

The interface 2600 may communicate with a host or other external devices. The interface 2600 may transmit/receive commands and data to/from the host according to a preset protocol. In some implementations, the interface 2600 is capable of transmitting/receiving commands and data to/from the host according to the SPDM standard protocol.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

1. A method of generating a device identifier of a storage device, the method comprising:
generating, by a device identifier composition engine, a first secret key and a first public key of a first layer based on a first hash value of the first layer;
generating, by the device identifier composition engine and based on a second secret key of a second layer that is an upper layer of the first layer, the first public key, and a first variable, a signature of the first public key until the signature satisfies a first condition, wherein a value of the first variable is different for each generated signature;
storing, by the device identifier composition engine, a first value of the first variable in a non-volatile memory device, wherein the signature that satisfies the first condition is generated based in part on the first value,
wherein generating the first public key, the first secret key, and the signature occur during a first booting process, and
wherein storing the first value of the first variable occurs during the first booting process; and
during a second booting process subsequent to the first booting process, reading the first value of the first variable from the non-volatile memory device and generating the signature of the first public key based on the first value of the first variable.

2. The method of claim 1,
wherein, during the first booting process, generating the signature comprises:
confirming that a value of the first variable is stored in the non-volatile memory device; and
based on confirming that the value of the first variable is stored, reading the value of the first variable from the non-volatile memory device, and generating the signature based on the read value of the first variable,
or wherein, during the first booting process, generating the signature comprises:
confirming that the value of the first variable is absent from the non-volatile memory device; and
based on confirming that the value of the first variable is absent from the non-volatile memory device, setting a second value to the first variable, and generating the signature based on the second value of the first variable.

3. The method of claim 1, wherein generating the signature during the second booting process comprises:
generating a first signature based on the first public key, the second secret key, and the first value of the first variable;
wherein, based upon the first signature failing to satisfy the first condition, changing the value of the first variable; and
generating a second signature based on the first public key, the second secret key, and the changed value of the first variable.

4. The method of claim 1, comprising generating, by the device identifier composition engine, a certificate for the first public key comprising the first public key and the signature.

5. The method of claim 1, wherein, based on the first layer failing to update before the second booting process, the first secret key, the first public key, and the signature generated during the second booting process are the same as the first secret key, the first public key, and the signature generated during the first booting process.

6. The method of claim 1, wherein, during the second booting process, the device identifier composition engine generates the signature that satisfies the first condition, without changing the first value of the first variable, based on the first public key, the second secret key, and the first value of the first variable.

7. The method of claim 1, wherein, based on the first layer updating before the second booting process, the first secret key, the first public key, and the signature generated during the second booting process are different from the first secret key, the first public key, and the signature generated during the first booting process.

8. The method of claim 7,
wherein, during the second booting process, the device identifier composition engine generates the signature based on the first public key, the second secret key, and the first value of the first variable, and
wherein, based on the signature failing to satisfy the first condition, the device identifier composition engine changes the value of the first variable to provide an updated value of the first variable, and re-generates the signature based on the updated value of the first variable.

9. The method of claim 3,
wherein the value of the first variable comprises a counter value, and
wherein, based on the first signature failing to satisfy the first condition during the first booting process, the device identifier composition engine repeatedly generates the signature while increasing the counter value.

10. The method of claim 3,
wherein the value of the first variable comprises a random value, and
wherein, based on the first signature failing to satisfy the first condition during the first booting process, the device identifier composition engine repeatedly generates the signature by generating a random number and changing the random value to the random number.

11. The method of claim 1,
wherein the first layer corresponds to a first software layer of the storage device, and
wherein the second layer corresponds to a second software layer or a hardware layer of the storage device.

12. The method of claim 1, comprising, prior to generating the first secret key and the first public key, generating, by the device identifier composition engine, the second secret key and a second public key of the second layer based on a unique value of the storage device.

13. The method of claim 1, comprising:
based on a second hash value of a third layer that is a lower layer of the first layer, generating, by the device identifier composition engine, a third secret key and a third public key of the third layer;
generating, by the device identifier composition engine, a signature of the third public key that satisfies a second condition while changing a value of a second variable based on the first secret key of the first layer, the third public key, and the value of the second variable; and
storing, by the device identifier composition engine, a third value of the second variable used for generating the signature that satisfies the second condition as the value of the second variable in the non-volatile memory device.

14. A method of generating a device identifier of a storage device, the method comprising:
generating, by a device identifier composition engine, a first secret key and a first public key of a current layer; and
generating, by the device identifier composition engine, a signature of the first public key based on the first public key of the current layer, a second secret key of a previous layer, a fixed number, and a variable;
wherein the generating of the signature comprises:
reading a first value of the variable stored as a value of the variable from a non-volatile memory device;
generating a first signature based on the second secret key, the first public key, the fixed number, and the first value of the variable;
determining that the first signature fails to satisfy a first condition;
based on the first signature failing to satisfy the first condition, repeatedly generating a new signature while changing the value of the variable until the new signature satisfies the first condition; and
storing, as the value of the variable in the non-volatile memory device, a second value of the variable associated with the new signature that satisfies the first condition.

15. The method of claim 14,
wherein, based on value of the variable not being stored in the non-volatile memory device, the value of the variable is set to 0 or any value, and the first signature is generated based on the second secret key, the first public key, the fixed number, and the value of the variable.

16. The method of claim 14,
wherein, during a first booting process, the device identifier composition engine generates the new signature as the signature of the first public key, and
wherein, during a second booting process that occurs after the first booting process, the device identifier composition engine:
reads the second value of the variable from the non-volatile memory device; and
generate a third signature as the signature for the first public key based on the second variable value without repeatedly generating the signature.

17. The method of claim 14,
wherein the fixed number comprises a random value and the value of the variable comprises a counter value, and
wherein the device identifier composition engine repeatedly generates the new signature while increasing the counter value, until the new signature satisfies the first condition.

18. A storage device comprising:
non-volatile memory; and
a device identifier composition engine configured to
generate a first secret key and a first public key of a first layer, a second secret key and a second public key of a second layer, and
generate a signature of the second public key based on the first secret key, the second public key, and a first variable,
wherein the device identifier composition engine is further configured to:
generate, during a first booting process, a first signature based on the first secret key, the second public key, and a first value of the first variable;
repeatedly generate a new signature while changing the value of the first variable based on the first signature failing to satisfy a condition; and
store a second value of the first variable associated with the new signature in the non-volatile memory as the value of the first variable based on the new signature satisfying the condition.

19. The storage device of claim 18, wherein the device identifier composition engine is configured to:
read a stored value of the first variable from the non-volatile memory based on the value of the first variable being stored in the non-volatile memory;
generate the signature of the second public key based on the stored value; and
generate the signature of the second public key based on any value based on the value of the first variable not being stored in the non-volatile memory.

20. The storage device of claim 18, wherein the device identifier composition engine is configured to, during a second booting process, read the second value of the first variable from the non-volatile memory, and generate the signature of the second public key based on the first secret key, the second public key, and the second value of the first variable.

21-24. (canceled)
